(19) United States
(12) Patent Application Publication
(10) Pub. No.: US 2020/0197920 A1
(43) Pub. Date: Jun. 25, 2020

(54) PROCESS FOR THE PREPARATION OF A CATALYST SYSTEM, CATALYST SYSTEM, AND ITS USE FOR THE PRODUCTION OF A CAST POLYAMIDE

(71) Applicant: L. Bruggemann GmbH & Co. KG, Heilbronn (DE)

(72) Inventors: Thomas EPPLE, Untereisesheim (DE); Matthias BRUCH, Heilbronn (DE)

(73) Assignee: L. Bruggemann GmbH & Co. KG, Heilbronn (DE)

(21) Appl. No.: 16/720,617

(22) Filed: Dec. 19, 2019

(30) Foreign Application Priority Data
Dec. 20, 2018 (EP) 18214390.9

(51) Int. Cl. B01J 37/00; C08G 69/20; B01J 37/04; B01J 31/02

(52) U.S. Cl. CPC B01J 37/0081; B01J 31/0211; B01J 37/04; C08G 69/20

(57) ABSTRACT

A process for the production of a catalyst system is described. For this purpose, at least one alkali metal alcoholate is introduced into a lactam melt and the resulting alcohol is removed. The resulting catalyst system is used for the production of cast nylon.

### DESCRIPTION

The present invention concerns a process for the preparation of a catalyst system suitable for the production of cast polyamide, the catalyst system obtained and its use.

### STATE OF THE ART

Cast polyamide is usually produced from two liquid components (A and B), each of which consists essentially of lactams. In order to carry out the reaction quickly and at temperatures below 200° C., an activator is added to component B (activator system) and a catalyst to the other component A. In industry, alkali metal lactamates, especially sodium caprolactamate, are most frequently used as catalysts. Component A (catalyst system) containing such a catalyst is produced by melting a lactam with an alkali metal alcoholate. This produces the catalytically active lactamate. After production, the melt of lactam and alkali metal lactamate is stored in the liquid state until use. Due to the melting point of the lactams, temperatures of 70-180° C. must be applied. However, there is the problem that such lactamate-containing melts show signs of ageing which adversely affect the activity and/or the cast polyamide to be produced or are disadvantageous due to the formation of deposits in the equipment used to produce cast polyamide.

After prolonged storage in the molten state, conventional components A show a turbidity due to the formation of insoluble solids, which already occurs without the addition of an activator. This can be explained as polymer and/or oligomer formation of the lactam. This premature polymer and oligomer formation in the catalyst melt causes deposits to form in the system which must be removed. This results in additional cleaning costs. In addition, undesired reactions can occur after mixing component A with component B (which contains the activator).

As activator for component B, the isocyanates, icocyanurates, biuretes, allophanates, uretdiones and/or carbodiimides known according to the state of the art can be used as single compounds or as a mixture. The corresponding oligomerized, polymerized or blocked compounds can also be used. Lactams, phenols, oximes and/or epoxides can be used as protective groups for blocking. The activators can be solid or liquid or solid activators can be converted into liquid form by using solvents. Bruggolen® C20P can be used as activator. Bruggolen® C20P is an N,N′-hexane-1,6-diylbis(hexahydro-2-oxo-1H-azepine-1-carboxamide, i.e. the hexamethylene diisocyanate (HDI) blocked with caprolactam.

For this reason, the catalyst system is often produced in-situ directly during polyamide production and is not stored in isolated form at all. This is described for example in CN 106 432 714 A, CN 104 004 346 A and CN 108 262 994 A. DE 1 495 132, U.S. Pat. No. 5,747,634 and EP 2 789 641 A1 describe conventional processes for polyamide production. The disadvantage of the conventional systems is that the catalyst has to be produced in-situ, which means that catalyst production has to be repeated for each new approach. Therefore, as already described above, there is a need for storage-stable catalysts which can then be easily added to the polymerization reaction as required. Processes for the production of lactam-containing catalyst systems and processes for their stabilization are known per se.

EP 238 143 B1, for example, describes the improvement of the shelf life of alkali metal lactamates in the molten state by the addition of 0.1-2 wt. % isopropanol or an aromatic or an aliphatic alcohol with 4-18 carbon atoms (with boiling points of 80-250° C.). These, however, remain in the melt in larger quantities of up to 2 wt. % during the production of cast polyamide, which can lead to gas formation which impairs the quality of the polyamide. Furthermore, such additional components must be evaluated and their composition controlled when the cast polyamide is used in life contact.

WO 2014/005791 A1 also describes an approach to improve the shelf life of alkali metal lactamates in the molten state by adding more than 1 wt. % of a salt or ester of an organic acid substituted with heteroatoms. Here too, the added stabilizing components remain in the polyamide, which influences the quality of the polyamide.

WO 2018/041642 A1 describes an approach to improve the shelf life of potassium lactamate in the molten state. For this purpose, potassium lactamate is produced from lactam and metallic potassium. However, the handling of metallic potassium is very demanding compared to the use of industrially available alkali metal alcoholates and involves risks.

The approaches described in the state of the art for improving the storage stability of lactam-containing catalyst systems therefore still have disadvantages.

### Object of the Present Invention

The task underlying the present invention thus consists in providing a process for the production of a catalyst system, a catalyst system, and in its use for the production of cast polyamide, whereby the disadvantages associated with the state of the art do not occur or occur only to a reduced extent.

In particular, the process should lead to a catalyst system in a simple manner, using easily manageable starting materials. At the same time, however, there should be no drop in catalyst activity apart from the desired stability, and it should preferably be possible to dispense with the use of additional components such as alcohols with boiling points higher than 80° C., special acids, etc. By dispensing with additional components, the composition of the cast polyamide produced with it is not changed, so that the additional components do not have to be evaluated and their composition controlled when the cast polyamide is used in life contact.

### BRIEF DESCRIPTION OF THE INVENTION

This task is solved by a procedure according to claim 1. Preferred embodiments of the present procedure are defined in subclaims 2 to 9 and in the description. Furthermore, this task is solved by a catalyst system according to claims 10 and 11. Preferred embodiments of the present catalyst system are defined in subclaims 12 to 14 and in the description.

In particular, this task is solved by a process for preparing a catalyst system by reacting at least one lactam with at least one alkali metal alcoholate, comprising the steps
a) Heating at least one lactam to obtain a lactam melt;
b) Introduction of at least one alkali metal alcoholate selected from alkali metal methanolate and alkali metal ethanolate into the lactam melt;
c) Removal of the alcohol formed in a vacuum;
   characterized in that the amount of alkali metal ethanolate is between 50 and 100% by weight relative to the total amount of alkali metal alcoholate.

This catalyst system can then be stored as such and used for polyamide production as required. The catalyst system obtained by the process is therefore not a polymerization mixture but is added to the starting materials for the production of polyamide as required to start the polymerization.

The surprising advantage of the present process is that the catalyst system obtained contains no traces of higher boiling (>80° C.) alcohols and no additives other than alkali metal lactamate and lactam. At the same time, the selection of the alkali metal alcoholate component results in an unexpectedly increased stability. Thus, when using the catalyst produced according to the invention in the production of cast nylon from lactam, good reactivity is observed and no adjustments of the formulation and casting parameters are necessary to produce cast nylon of high quality. At the same time, the disadvantages occurring in the state of the art can be overcome and the undesired premature polymer or oligomer formation can be suppressed.

The present process results in a catalyst system which, on the one hand, has excellent reactivity when used for the production of cast polyamide, but, on the other hand, also allows a longer storage time of the tempered melt of catalyst and lactam.

### DETAILED DESCRIPTION OF THE INVENTION

In the following, the procedure according to the invention is explained in more detail.

In the process according to the invention, at least one lactam is provided. “At least one lactam” in the context of the present invention means both exactly one lactam and a mixture of two or more lactams.

According to the invention, “lactam” is understood to be cyclic amides which have 4 to 12 carbon atoms in the ring, preferably 6 to 12 carbon atoms.

Suitable lactams are for example selected from the group consisting of 4-aminobutanoic acid lactam (γ-lactam; γ-butyrolactam; pyrrolidone), 5-aminopentanoic acid lactam (δ-lactam; δ-valerolactam; piperidone), 6-aminohexanoic acid lactam (ε-lactam; ε-caprolactam), 7-aminoheptanoic acid lactam (ζ-lactam; ζ-heptanolactam; enanthlactam), 8-aminooctanoic acid lactam (η-lactam; η-octanolactam; capryllactam), 9-nonanoic acid lactam (Θ-lactam; Θ-nonanolactam), 10-decanoic acid lactam (ω-decanolactam; caprinlactam), 11-undecanoic acid lactam (ω-undecanolactam) and 12-dodecanoic acid lactam (ω-dodecanolactam; laurolactam)

Lactams such as β-lactam, γ-lactam, δ-lactam, ε-lactam and lauric lactam are particularly preferred. Especially preferred are ε-lactams, especially caprolactam.

Examples of suitable alkali metal alcoholates are alkali metal methanolates and alkali metal ethanolates, sodium methanolate and sodium ethanolate being particularly preferred, sodium ethanolate being particularly preferred. Examples of other suitable alkali metals are lithium and potassium, so that suitable alkali metal alcoholates can also be selected from lithium methanolate and lithium ethanolate, as well as potassium methanolate and potassium ethanolate.

In the present process, the amount of alkali metal ethanolate is between 50 and 100% by weight, preferably 70 to 100% by weight, more preferably 90 to 100% by weight and particularly preferably 100% by weight, each based on the total amount of alkali metal alcoholate.

In the present process, the amount of alkali metal methanolate is between 0 and 50% by weight, preferably 0 to 30% by weight, more preferably 0 to 10% by weight and in particular 0% by weight, in each case based on the total amount of alkali metal alcoholate. In a particularly preferred form, only alkali metal ethanolate is provided, so that the amount of alkali metal methanolate is 0 wt. %. In this case a methanol-free catalyst system is formed.

It is completely unexpected that by using an alkali metal alcoholate component, which consists of at least 50% by weight of alkali metal ethanolate, according to the invention, a catalyst system can be obtained which has improved stability in the melt with excellent reactivity. According to the invention, the stabilizing components proposed in the state of the art, such as higher boiling alcohols or salts or esters of an organic acid substituted with heteroatoms, can thus be dispensed with. Also, no alkali metal in elemental form with an increased hazard potential has to be used, but conventional, easier to handle components (alkali metal alcoholates) can be used. This simplifies the process, as the number of components to be used remains small and expensive protective measures, necessary when using elemental alkali metals, are not required.

In the process according to the invention, the lactam or mixtures of lactams, for example, is melted at a temperature in the range of 80 to 180° C., preferably in the range of 90 to 150° C. and especially preferably in the range of 100 to 130° C.

In the process according to the invention, the quantity of alkali metal alcoholate used is controlled in such a way that, for example, 8 to 28 wt. % alkali metal lactamate, preferably 10 to 25 wt. % and in particular preferably 15 to 20 wt. % alkali metal lactamate, is formed in the melt with the lactam, in each case based on the total weight of the catalyst system.

The alkali metal alcoholate or the mixture of alkali metal alcoholates is preferably introduced into the lactam melt in the solid state as a powder.

Preferably, no alcohols are used in the process according to the invention. By the exclusive use of alkali metal alcoholates, the amount of alcohol to be separated is minimized in the process according to the invention.

In the process according to the invention, the alcohol formed is removed as quickly as possible, preferably within 5, more preferably within 4 and in particular within 3 minutes, preferably by applying a vacuum until a pressure of less than 100 mbar, particularly preferably less than 50 mbar and very particularly preferably less than 20 mbar is reached.

Due to the process described above, the catalyst system manufactured according to the invention contains low residual alcohol contents. These are typically 0.3 wt. % or less, such as 0.2 wt. % or less, preferably 0.1 wt. % or less, in particular preferably the catalyst system according to the invention does not contain any other alcohols than traces of methanol and/or ethanol, based on the total amount of the catalyst system obtained.

The process described above also includes a finishing step. The catalyst system obtained is assembled. The catalyst system is preferably prepared on a shingle roller or a pastillation belt. The catalyst system obtained can be stored in the molten or solid state.

In a particularly preferred embodiment, the process according to the invention for the production of a catalyst system by reacting caprolactam with sodium ethanolate comprises the steps
a) Heating the caprolactam to obtain a caprolactam melt;
b) Introduction of the sodium ethanolate into the caprolactam melt;
c) Removal of the ethanol formed while retaining the catalyst system.

In the process according to the invention, work can be carried out in individual or all process steps to the exclusion of ambient atmospheric oxygen or humidity, for example by using inert gas, for example nitrogen.

A catalyst system obtained by the process of preparing a catalyst system by reacting at least one lactam with at least one alkali metal alcoholate as described above.

In the following, the catalyst system according to the invention is explained in more detail.

According to the invention, the catalyst system contains at least one lactam. “At least one lactam” in the context of the present invention means both exactly one lactam and a mixture of two or more lactams.

According to the invention, “lactam” is understood to be cyclic amides which have 4 to 12 carbon atoms in the ring, preferably 6 to 12 carbon atoms.

Suitable lactams are for example selected from the group consisting of 4-aminobutanoic acid lactam (γ-lactam; γ-butyrolactam; pyrrolidone), 5-aminopentanoic acid lactam (δ-lactam; δ-valerolactam; piperidone), 6-aminohexanoic acid lactam (ε-lactam; ε-caprolactam), 7-aminoheptanoic acid lactam (ζ-lactam; ζ-heptanolactam; enanthlactam), 8-aminooctanoic acid lactam (η-lactam; η-octanolactam; capryllactam), 9-nonanoic acid lactam (Θ-lactam; Θ-nonanolactam), 10-decanoic acid lactam (ω-decanolactam; caprinlactam), 11-undecanoic acid lactam (ω-undecanolactam) and 12-dodecanoic acid lactam (ω-dodecanolactam; laurolactam)

Lactams such as β-lactam, γ-lactam, δ-lactam, ε-lactam (caprolactam) and lauric lactam are particularly preferred. Especially preferred is ε-lactame, especially caprolactam.

Preferably, the catalyst system according to the invention does not contain any other components. The catalyst system according to the invention preferably consists of lactam and lactamate.

The catalyst system according to the invention contains, for example, in the range from 8 to 28 wt. %, preferably in the range from 10 to 25 wt. % and particularly preferably in the range from 15 to 20 wt. % alkali metal lactamate, in each case based on the total weight of the catalyst system.

The sum of the percentages by weight of the components contained in the catalyst system and any other components contained in the catalyst system usually add up to 100% by weight. It is preferable to keep the number of further components as low as possible, and it is particularly preferable to limit such further components to lactams, especially caprolactam.

In a particularly preferred embodiment, the catalyst system according to the invention consists of caprolactam and 18% by weight of sodium caprolactamate, characterized in that the catalyst system contains only traces of alcohol, based on the total amount of the catalyst system, which result exclusively from the reaction of the added alcoholates. Particularly preferably, the catalyst system according to the invention contains, in addition to traces of methanol and/or ethanol, in particular no further higher boiling alcohols (>80° C.), based on the total amount of the catalyst system.

The catalyst system according to the invention can be present as a melt (in the molten state) or as a solid (in the solid state). The catalyst system according to the invention is preferred as a solid in the variant described here (in flake form or as pastilles). In order to obtain the catalyst system as a solid, the catalyst system is prepared from the molten state using a flake roller or a pastille belt.

A further object of the present invention is the use of the catalyst system according to the invention in the production of polyamide, in particular in the production of cast polyamide.

With the catalyst system obtained, the polymerization of lactams into polyamides (with simultaneous use of the above described and necessary activator component) can be directly initiated in both continuous and discontinuous processes. The discontinuous process is preferred. The catalyst system obtained can be used in extrusion, injection moulding, pultrusion, monomer casting, resin transfer moulding, reaction injection moulding and rotor moulding processes as well as for the production of composite materials with polyamide as matrix.

The present invention is described in more detail on the basis of the following examples, which, however, do not constitute a limitation of the invention.

### Determination of the Polymerization Reactivity T1 and T2

The reactivity of the catalyst system is determined by the anionic polymerization at time T1 [s], the solidification of the clear melt, i.e. the meniscus of the melt no longer moves when the test tube is moved, and at time T2 [s], the clouding of the melt.

Molten catalyst component A and a suitable activator component B in lactam polymerize to polyamide. This results in different polymerization times, which are defined visually.

Weigh 18,75 g caprolactam into each of two test tubes (A and B). The test tubes are each closed with a rubber stopper. The test tubes are then tempered in a heat bath at 140° C. until the caprolactam has melted. Weigh 1.5 g of the catalyst system into test tube A. Add 1.05 g of the activator Bruggolen® C20P (N,N′-hexane-1,6-diylbis(hexahydro-2-oxo-1H-azepine-1-carboxamide) to test tube B. Then homogenize with a glass rod. After reaching a temperature of 130° C. in test tube A (the temperature is measured directly in the test tube), the test tube is removed from the heat bath and the contents of test tube B are poured into that of test tube A. Test tube A is now closed again with a stopper and the contents are homogenised by shaking briefly and vigorously. The test tube is then immediately placed back in the tempering bath and the stopwatch is started at the same time.

The progress of the polymerization of the mixture is determined visually. The following points in time are determined.

T1: The mass no longer follows the movement with slight back and forth swinging.

T2: Occurrence of turbidity of the solution that was clear until then.

The reaction times T1 and T2 are a measure of the reactivity of the system. The lower the T1 and T2 values, the higher the polymerization reactivity.

Determination of the Melt Stability (48 h/85° C.)

This method is used to determine the melt stability of the catalyst system.

The catalyst system melts at 65° C. and usually produces a clear melt. Depending on the temperature, concentration and service life, however, the melt slowly becomes milky cloudy and highly viscous. This undesired change is due to the undesired reaction of the catalyst and caprolactam. The water-insoluble precipitate that forms is determined gravimetrically and represents the assessment parameter for melt stability. The lower the amount of the water-insoluble solid formed, the higher the melt stability.

Weigh 50 g caprolactam (mₐ) (technical) into a dried 250 ml two-necked round-bottomed flask. The round-bottomed flask is evacuated and the contents are kept under vacuum up to a temperature of approximately 65° C. Then the round-bottomed flask is filled with nitrogen and the caprolactam is melted. The temperature of 85° C. must not be exceeded. 100 g catalyst (mb) are added and the contents are briefly kept under vacuum. Then switch back to nitrogen and melt the contents of the flask completely. The temperature must not exceed 85° C. The contents of the flask are tempered for 48 hours at 85° C. in a drying oven. After tempering, 100 ml of water is added to the flask contents and homogenised by stirring. Then filter through a round filter and wash 3 times with 100 ml water each time without alkali. The residue (m_{R}) remaining on the round filter is dried for 2 h at 105° C., cooled to room temperature in the desiccator and then weighed.

The percentage water-insoluble content of the sample is calculated according to the following equation and expressed in weight %.

$$= \frac{( {m}_{R} )}{( {m}_{a} + {m}_{b} )} \cdot 100 \%$$

Gravimetric determination of water-insoluble solids: The more water-insoluble solids are formed, the more turbid the solutions become and the higher the weight of the insoluble fraction. The lower the solids content determined in this way, the less unwanted ageing has occurred.

Determination of the Melt Stability (5 h/85° C.)

Instead of the quantitative gravimetric determination after 48 hours, a visual assessment after 5 h at 85° C. can also be performed. The more undesired ageing occurs, the more cloudy the solutions become. The prepared catalyst systems are stored in the test tube for 5 h at 85° C. in a drying oven. The clarity of the melt is then determined by a quantitative spectroscopic method. For this purpose, 0.5 g sample is dissolved in 19.5 g deionized water and examined for transmission in a cell with a path length of 50 mm. The transmittance is determined at wavelength=450 nm in comparison to a cell with a path length of 50 mm filled only with deionized water. The higher the transmission value T in % of the melt stability (5h/85° C.), the less aging has occurred, i.e. the higher the melt stability.

In the ideal case the transmission value T is 100%.

### Determination of the Residual Alcohol Content

The residual alcohol content in the catalyst system is determined by gas chromatography and is known to the expert.

### EXAMPLES

The production of the alkali metal lactams takes place in a 500 litre vessel. 400 kg of caprolactam is added and melted (approx. 80-140° C.). The solid alkali alcoholate (sodium ethanolate or sodium methanolate or mixtures thereof) is added (the quantity is chosen so that 18% by weight of the caprolactam is converted into sodium caprolactamate, i.e. 29 kg of sodium methanolate if only sodium methanolate is added). The vessel is quickly closed and vacuum is applied to remove any volatile alcohol (ethanol and/or methanol) produced. After the removal of the resulting alcohol at an internal pressure of less than 100 mbar, the composition is transferred to a shingle roller or pelleting belt. The resulting compositions in the form of solid flakes were evaluated as described above. The results are given in the tables below, together with the alkali metal alcoholates used in each case.

TABLE 1
Examples B1 and B2: Sodium ethanolate:sodium methanolate
(1:1), Residual alcohol content ≤0.3% by weight

| Parameters | B1 | B2 |
|---|---|---|
| Reactivity T1 [s] | 34 | 34 |
| Reactivity T2 [s] | 54 | 53 |
| Melt stability [wt. %]. | 3.0 | 1.9 |
| (48 h/85° C.) | | |
| Melt stability [% T] | 90 | 100 |
| (5 h/85° C.) | | |

TABLE 2
Comparative examples VB1 and VB2: Preparations with
sodium methanolate (100% by weight), residual alcohol
content >0.3% by weight. Examples B3 and B4: preparations
with sodium ethanolate (100% by weight), Residual
alcohol content ≤0.3% by weight

| Parameters | VB1 | VB2 | B3 | B4 |
|---|---|---|---|---|
| Reactivity T1 [s] | 23 | 23 | 29 | 25 |
| Reactivity T2 [s] | 46 | 43 | 49 | 45 |
| Melt stability | 0.8 | 1.0 | 0.2 | 0.3 |
| (48 h/85° C.) | | | | |
| [weight %]. | | | | |
| Sodium lactamate | 17.7 | 17.6 | 17.7 | 18.1 |
| [% by weight] | | | | |
| Melt stability | 39 | 50 | 100 | 100 |
| (5 h/85° C.) [% T]. | | | | |

The advantages of the procedure according to the invention can be summarised as follows:

In comparison to the state-of-the-art processes, practically no water-insoluble solid is formed, which is shown by a comparison with the tests described above. The comparative examples VB1 and VB2, produced with sodium methanolate only, show a melt stability (48 h/85° C.) of 0.8 and 1% and a melt stability (5 h/85° C.) of 39 and 50%. The examples B1 and B2, produced with 50 wt. % sodium ethanolate, show a worse melt stability (48 h/85° C.) of 3.0 and 1.9%, but the values of melt stability (5 h/85° C.) of 90 and 100% are clearly better. In examples B3 and B4, produced with 100 wt.% sodium ethanolate, i.e. without sodium methanolate, both an improved melt stability (48 h/85° C.) of 0.2 and 0.3% and an improved melt stability (5 h/85° C.) of 100 and 100% are measured. According to the invention, by applying a vacuum during catalyst production, the predominant portion of the alcohol produced can be removed, so that the product is essentially free of alcohols (methanol/ethanol).

The examples according to the invention show that an improved storage stability in the molten state of alkali metal lactamates in lactam can be achieved by the sole use of alkali metal ethanolate or by the use of a mixture with alkali metal methanolate, with at least 50% by weight alkali metal ethanolate in the synthesis. When using 100% by weight alkali metal ethanolate, the best values are obtained both for melt stability (48 h/85° C.) and for melt stability (5 h/85° C.). Ethanol or ethanol-methanol mixture resulting from the reaction is removed as quickly as possible by applying a strong vacuum. Even if this is also done when using an alkali metal methanolate alone, there is no improvement in storage stability. The advantage over state-of-the-art processes is that the product contains no traces of higher-boiling (>80° C.) alcohols and no substances other than alkali metal (capro)lactamate and (capro)lactam. Thus, when using the process according to the invention for the production of polyamide, in particular polyamide-6 from caprolactam, good reactivity is observed in the production of cast polyamide and no adjustments of the formulation and casting parameters are necessary to produce high-quality polyamide.

In the production of cast polyamide, the catalyst system obtainable by the process according to the invention can be used, whereby the use of the catalyst system obtained according to the invention in the case of the cast polyamide parts leads to excellent crystallinity, to constant reactivity and to longer storage times of the tempered melt of catalyst and lactam. In addition, the process according to the invention provides a lactamate catalyst for polyamide production which has a small fluctuation in the active ingredient content of sodium (capro)lactamate. In the production of polyamide using the lactamate according to the invention as catalyst, smaller amounts of catalyst can therefore be used and constant polymerization times can be realized.

Already during storage of the catalyst systems, sometimes undesired reactions of the catalyst with (capro)lactam take place to form a water-insoluble solid. The disadvantages of the presence of water-insoluble solids, consisting of polymers and oligomers, in the catalyst system are, on the one hand, that higher costs are incurred for cleaning the equipment. On the other hand, inhomogeneities occur during polymerization due to the high polymer and oligomer content. Since different polymerization rates occur within the polymerization zone, inhomogeneities are formed in the resulting polymer. As was shown in the comparison of the examples according to the invention with the comparative examples, the process according to the invention has surprisingly succeeded in reducing the proportion of water-insoluble solids which interfere with the polymerization to a very low level.

1. A process for preparing a catalyst system by reacting at least one lactam with at least one alkali metal alcoholate, the process comprising:
a) heating at least one lactam to obtain a lactam melt;
b) introducing to the lactam melt at least one alkali metal alcoholate selected from alkali metal methanolate and alkali metal ethanolate into the lactam melt; and
c) removing from the lactam melt alcohol formed during the process;
wherein the amount of the alkali metal ethanolate is between 50 and 100% by weight relative to the total amount of alkali metal alcoholate.

2. Process The process according to claim 1, wherein the amount of alkali metal ethanolate is between 70 and 100% by weight relative to the total amount of alkali metal alcoholate.

3. Process The process according to claim 1, wherein the alkali metal alcoholate is the alkali metal ethanolate.

4. The process according to claim 1, wherein the at least one lactam is selected from β-lactam, γ-lactam, δ-lactam, ε-lactam and lauric lactam.

5. The process according to claim 1, wherein the at least one alkali metal alcoholate is selected from sodium alcoholate, lithium alcoholate and potassium alcoholate.

6. The process according to claim 5, wherein the lactam is ε-lactam.

7. The process according to claim 1, wherein the at least one alkali metal alcoholate is sodium ethanolate.

8. The process according to claim 1, wherein the catalyst system obtained has a residual alcohol content of 0.3% by weight or less based on the total amount of the catalyst system.

9. The process according to claim 1, wherein the process further comprises finishing the catalyst system.

10. A catalyst system obtainable by the process according to claim 1.

11. The catalyst system according to claim 10, wherein the catalyst system has a residual alcohol content of 0.3% by weight or less.

12. The catalyst system according to claim 11, wherein the amount of alkali metal lactamate is between 8 and 28% by weight based on the total amount of the catalyst system.

13. The catalyst system according to claim 10, wherein the alkali metal lactamate is selected from lithium lactamate, sodium lactamate and potassium lactamate.

14. The catalyst system according to claim 10, wherein the lactam is selected from β-lactam, γ-lactam, δ-lactam, ε-lactam and lauric lactam.

15. A polyamide prepared according to the process of claim 1, the process further comprising polymerizing the lactam melt into a polyamide.

16. The polyamide of claim 15, the process further comprising casting the polyamide into a cast polyamide.

17. The polyamide of claim 15, wherein the polyamide has a residual alcohol content of not more than 0.3% by weight.

18. The catalyst system of claim 11, wherein the catalyst system is essentially free of water-insoluble solids.

19. The catalyst system of claim 11 in the form of a melt.

20. The catalyst system of claim 11 in the form of a solid.
